(19) United States
(12) Patent Application Publication
(10) Pub. No.: US 2010/0015721 A1
(43) Pub. Date: Jan. 21, 2010

(54) Detection of Promiscuous Small Submicrometer Aggregates

(75) Inventor: Lance Laing, Belmont, MA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: SRU Biosystems, Inc.

(21) Appl. No.: 12/478,534

(22) Filed: Jun. 4, 2009

Related U.S. Application Data
(60) Provisional application No. 61/058,738, filed on Jun. 4, 2008.

(51) Int. Cl. G01N 21/76

(52) U.S. Cl. 436/172

(57) ABSTRACT

The invention provides methods for the detection of aggregating molecules that are capable of promiscuous or non-specific binding to proteins in a time efficient manner without the use of labels.

### PRIORITY

This application claims the benefit of U.S. Ser. No. 61/058,738, filed on Jun. 4, 2008, which is incorporated herein by reference in its entirety.

### BACKGROUND OF INVENTION

Recent articles have described issues associated with small drug-like compounds that do not fit the classical 1:1 stoichiometric target association model. Giannetti et al., J. Med. Chem. 2008, 51:574-580; Ryan et al., J. Med. Chem. 2003, 46:3448-3451; Cai & Gochi, J. Biomol. Screen 2007, 12:966; Iyer et al., J. Biomolec. Screen., 2006, 11:782-791; Feng et al., Nat. Chem. Bio., 2005, 1:146-148; Yao et al., DrugPlus Int. April/May, 2005; Yang et al., 2005. Nat. Chem. Biol. 1:146; McGovern et al., 2002, J. Med. Chem. 45:1712; McGovern et al., 2003, J. Med. Chem. 46:4265. Particular attention has focused on a behavior that is associated with formation of small compound aggregates (size of about 30 to about 400 nm) that can interact with protein surfaces and thereby inactivate targets. Some compounds displaying this behavior inhibit a wide range of different proteins, and hence have been termed “promiscuous,” though other compounds can show remarkable specificity and potency. Such behavior can lead to the initial progression of compounds with undesirable properties or conversely result in the omission of weaker but more desirable binders. Measurements based on effects of function have been used to distinguish such behavior from classical inhibitors. These types of molecules can cause false positive results in, e.g., high throughput screening of compound libraries. Therefore, methods of quickly identifying these compounds are needed in the art.

### SUMMARY OF INVENTION

One embodiment of the invention provides methods of detecting aggregate-forming particles or promiscuous inhibitor molecules. The method comprises applying test species to a calorimetric resonant reflectance biosensor or a grating-based waveguide biosensor and illuminating the biosensor with light and determining peak wavelength value shifts or refractive index changes over time. Discontinuous, non-linear, or slope of greater than 2 pm/minute peak wavelength value shifts or refractive index changes over time indicates that the test species are aggregate-forming particles or promiscuous binding molecules. The biosensor can have one or more specific binding substances, binding partners or linkers immobilized on a surface of the biosensor. The stoichiometry of a binding reaction between the test species and the one or more specific binding substances, binding partners or linkers greater than about 1:1 indicates that the test species are aggregate-forming particles or promiscuous binding molecules. The biosensor can have a hydrophilic coating on the biosensor surface. The refractive index change or peak wavelength value shift can be continuously measured over an about 15 second to about a 10 minute time period. The biosensor can be a bottom surface of one or more microtiter wells. The test species can be added at several different concentrations to several different microtiter wells. The peak wavelength values or refractive index values can be determined at a distance of about 100 up to about 300 nm off of the surface of the biosensor.

Still another embodiment of the invention provides a method of detecting non-specific binding of a test species. The method comprises applying test species to a calorimetric resonant reflectance biosensor or a grating-based waveguide biosensor, wherein the biosensor has one or more specific binding substances, binding partners or linkers immobilized on a surface of the biosensor and illuminating the biosensor with light and determining peak wavelength value shifts or refractive index changes over time. Discontinuous, non-linear or slope of greater than 2 pm/minute peak wavelength value shifts or refractive index changes over time indicates that the test species is non-specifically binding. The stoichiometry of a binding reaction between the test species and the one or more specific binding substances, binding partners or linkers greater than about 1:1 indicates that the test species is non-specifically binding. The refractive index change or peak wavelength value shift can be continuously measured over an about 15 second to about a 10 minute time period. The peak wavelength values or refractive index values can be determined at a distance of about 100 to about up nm off of the surface of the biosensor. The biosensor can be a bottom surface of one or more microtiter wells. The test species can be added at several different concentrations to several different microtiter wells.

Yet another embodiment of the invention provides a method of detecting non-specific binding of a test species. The method comprises applying a test species at varying concentrations to two or more locations on a calorimetric resonant biosensor or a grating-based waveguide biosensor, wherein the biosensor has one or more specific binding substances, binding partners, or linkers immobilized to the biosensor surface and illuminating the biosensor with light and detecting peak wavelength values or refractive index values for each of the two or more locations. A discontinuous, non-linear, or slope of greater than 2 pm/minute peak wavelength value shift or refractive index change with regard to increasing concentration of the test species indicates that the test species is non-specifically binding. Stoichiometry of a binding reaction between the test species and the one or more specific binding substances, binding partners or linkers greater than about 1:1 indicates that the test species is non-specifically binding. The refractive index change or peak wavelength value shift can be continuously measured over an about 15 second to about a 10 minute time period. The peak wavelength values or refractive index values can be determined at a distance of about 100 up to about 300 nm off of the surface of the biosensor. The biosensor can be a bottom surface of one or more microtiter wells. The test species can be added at several different concentrations to several different microtiter wells.

Even another embodiment of the invention provides a method of detecting aggregate-forming particles or promiscuous inhibitor molecules. The method comprises applying a test species at varying concentrations to two or more locations on a colorimetric resonant biosensor or a grating-based waveguide biosensor and illuminating the biosensor with light and detecting peak wavelength values or refractive index values for each of the two or more locations. A discontinuous, non-linear, or slope of greater than 2 pm/minute peak wavelength value shift refractive index change with regard to increasing concentration of the test species indicates that the test species is an aggregate-forming particle or a promiscuous inhibitor. The biosensor can have one or more specific binding substances, binding partners, or linkers immobilized to the biosensor surface. Stoichiometry of a binding reaction between the test species and the one or more specific binding substances, binding partners or linkers greater than about 1:1 indicates that the test species are aggregate-forming particles or promiscuous binding molecules. The biosensor can have a hydrophilic coating on the biosensor surface. The peak wavelength values or refractive index values can be determined at a distance of about 100 up to about 300 nm off of the surface of the biosensor. The refractive index change or peak wavelength value shift can be continuously measured over an about 15 second to about a 30 minute time period. The biosensor can be a bottom surface of one or more microtiter wells. The test species can be added at several different concentrations to several different microtiter wells.

Another embodiment of the invention provides a method of detecting promiscuous inhibitor molecules or aggregate-forming particles. The method comprises applying a ligand to a first location of a biosensor, wherein the biosensor has a target molecule comprising a specific binding site for the ligand immobilized on the first location and a second location of the biosensor. A test species is added to the first and second locations of the biosensor. A molecule known to bind to the target molecule at the specific binding site of the target molecule is added to the first and the second locations of the biosensor. The biosensor is illuminated with light and peak wavelength value shifts or refractive index changes at steps (a)-(c) are determined along with stoichiometric ratios of binding reactions at the first and second locations of the biosensor such that promiscuous inhibitor molecules or aggregate-forming particles are detected. The peak wavelength values or refractive index values are determined at a distance of about 100 up to about 300 nm off of the surface of the biosensor.

One embodiment of the invention provides a method of detecting an aggregate-forming molecule. The method comprises applying a test species to a calorimetric resonant biosensor or a grating-based waveguide biosensor and illuminating the biosensor with light. A significant and discontinuous refractive index change or peak wavelength value (PWV) shift with regard to increasing concentration of the test species indicates that the test species is an aggregate-forming molecule.

Another embodiment of the invention provides a method of differentiating between non-specific binding and specific binding of a test species. The method comprises applying a test species to a calorimetric resonant biosensor or a grating-based waveguide biosensor and illuminating the biosensor with light. A significant refractive index change or PWV shift with regard to increasing concentration of the test species indicates that the test species is non-specifically binding.

Yet another embodiment of the invention provides a method of detecting non-specific binding of a test species. The method comprises applying a test species to a calorimetric resonant biosensor or a grating-based waveguide biosensor and illuminating the biosensor with light. A significant or non-linear PWV shift or refractive index change with regard to increasing concentration of the test species indicates that the test species is non-specifically binding.

Still another embodiment of the invention provides a method of differentiating between non-specific binding and specific binding of a test species. The method comprises applying a test species to a calorimetric resonant biosensor or a grating-based waveguide biosensor and illuminating the biosensor with light. A discontinuous refractive index change greater than that calculated based upon the amount of test species immobilized on the biosensor and with regard to increasing concentration of the test species indicates that the test species is non-specifically binding.

Therefore, the invention provides methods for the detection of aggregating molecules that are capable of aggregation and/or promiscuous or non-specific binding to proteins without the use of labels in a time efficient manner.

### BRIEF DESCRIPTION OF THE DRAWINGS

FIG. 1: Mechanistic insight from time-courses of binding. Examples of time-courses with a mechanistically acceptable binding profile and others that have varying levels of non-specific interaction. The plots show representative examples of each category of compound binding (A, B, C, D) response commonly seen during a single concentration screen (see Table 1). The insert provides a closer look at the binding time courses for compounds in category C and D.

FIG. 2: Use of dose-response curves to K_{d}, stoichiometry and detect non-specific binding. Panel A shows an example of a compound that shows only specific, saturable binding. The solid line is the fit to a 1:1 binding model with K_{d} of 1.2 μM and a stoichiometry close to 1:1 (1:1 stoichiometry is 26 pm). Panel B shows an example of a compound that binds specifically low concentrations around its K_{d}, but shows additional non-specific binding at and above its K_{d}. The full-dose response curve does not show saturation and goes about 1:1 stoichiometry (1:1 stoichiometry is about 70 pm). The solid line shows how such data can readily be fitted to a model based on 1:1 binding combined with a linear function to represent a non-specific component to yield the K_{d} (4 μM) and stoichiometry of the specific binding component. The dashed line shows the predicted binding curve for specific binding with 1:1 stoichiometry.

FIG. 3: Confirmation of specific-site binding by competition. The ATPase domain target was immobilized in all biosensor wells and saturating amounts of a reversible specific site-binder was added to half the plate and binding of test compounds to the target (blocked or unblocked) was measured. A plot of the signal on blocked versus unblocked is useful to determine the same site and alternative site binding.

FIG. 4 shows a biosensor signal as a function of the distance of the added material to the biosensor surface.

### DETAILED DESCRIPTION OF THE INVENTION

As used herein, the singular forms “a,” “an”, and “the” include plural referents unless the context clearly dictates otherwise.

In one embodiment, the invention provides a method for detecting aggregate-forming particles and/or promiscuous inhibitor molecules or non-specific binding inhibition on a colorimetric resonant biosensor and/or a grating-based waveguide biosensor. See e.g., Cunningham et al., “Colorimetric resonant reflection as a direct biochemical assay technique,” Sensors and Actuators B, Volume 81, p. 316-328, Jan. 5, 2002; U.S. Pat. Publ. No. 2004/0091397; U.S. Pat. No. 6,958,131; U.S. Pat. No. 6,787,110; U.S. Pat. No. 5,738,825. Colorimetric resonant biosensors and grating-based waveguide biosensors are not surface plasmon resonant (SPR) biosensors. SPR biosensors have a thin metal layer, such as silver, gold, copper, aluminum, sodium, or indium. The metal must have conduction band electrons capable of resonating with light at a suitable wavelength. The SPR biosensor surface exposed to light must be pure metal. Oxides, sulfides and other films interfere with SPR. Colorimetric resonant biosensors do not have a metal layer, rather they have a dielectric coating of high refractive index, such as TiO₂. Additionally, it is difficult to detect aggregating compounds in SPR flow devices because of clogging of the very narrow channels or the very low binding affinity of the aggregate affected by the flow. Colorimetric resonant reflectance biosensors and grating-based waveguide biosensors are also capable of detecting aggregating compounds better than SPR devices because they can be made to detect changes farther away from the biosensor surface than SPR biosensors and do not require the use of narrow flow channels.

### Colorimetric Resonant Reflectance Biosensors

A calorimetric resonant reflectance biosensor allows biochemical interactions to be measured on or near the biosensor's surface without the use of fluorescent tags, calorimetric labels or any other type of tag or label. A biosensor surface contains an optical structure that, when illuminated with collimated white light, is designed to reflect only a narrow band of wavelengths. The narrow wavelength band is described as a wavelength “peak.” The “peak wavelength value” (PWV) changes when materials, such as biological materials, are deposited on the biosensor surface, are near the biosensor surface, or are removed from the biosensor surface. A readout instrument is used to illuminate distinct locations on a biosensor surface with collimated white light, and to collect collimated reflected light. The collected light is gathered into a wavelength spectrometer for determination of a PWV shift.

A biosensor can be incorporated into standard disposable laboratory items such as microtiter plates by bonding the structure (biosensor side up) into the bottom of a bottomless microtiter plate or similar cartridge. Incorporation of a biosensor into common laboratory 4″×6″ microtiter plate format or similar cartridges is desirable for compatibility with existing test sample handling equipment such as mixers, incubators, and liquid dispensing equipment.

Colorimetric resonant reflectance biosensors comprise subwavelength structured surfaces, which are an unconventional type of diffractive optic that can mimic the effect of thin-film coatings. (Peng & Morris, “Resonant scattering from two-dimensional gratings,” J. Opt. Soc. Am. A, Vol. 13, No. 5, p. 993, May 1996; Magnusson, & Wang, “New principle for optical filters,” Appl. Phys. Lett., 61, No. 9, p. 1022, August, 1992; Peng & Morris, “Experimental demonstration of resonant anomalies in diffraction from two-dimensional gratings,” Optics Letters, Vol. 21, No. 8, p. 549, April, 1996). A SWS structure contains a one-dimensional, two-dimensional, or three dimensional grating in which the grating period is small compared to the wavelength of incident light so that no diffractive orders other than the reflected and transmitted zeroth orders are allowed to propagate. Propagation of guided modes in the lateral direction are not supported. Rather, the guided mode resonant effect occurs over a highly localized region of approximately 3 microns from the point that any photon enters the biosensor structure.

The reflected or transmitted light of a calorimetric resonant reflectance biosensor can be modulated by the addition of molecules such as specific binding substances or binding partners or both to the surface or near the surface of the biosensor. The added molecules increase the optical path length of incident radiation through the structure, and thus modify the wavelength at which maximum reflectance or transmittance will occur.

In one embodiment, a calorimetric resonant reflectance biosensor, when illuminated with white light, is designed to reflect a single wavelength or a narrow band of wavelengths. When specific binding substances are attached to the surface of the biosensor, or are located on the biosensor surface or are close to the biosensor surface the reflected wavelength is shifted due to the change of the optical path of light that is shown on the biosensor. By linking specific binding substances to a biosensor surface, complementary binding partner molecules can be detected without the use of any kind of fluorescent probe, particle label or any other type of label. The detection technique is capable of resolving changes of, for example, ˜0.1 nm thickness of protein binding, and can be performed with the biosensor surface either immersed in fluid or dried. Additionally, molecules can be close to the biosensor (but not bound to or directly deposited on the surface) and a reading can still be observed. The distance molecules can be from the surface and still detected is determined by stacking alternating layers of PEI & PSS-PAH (poly ethyleneimine and poly sodium 4-styrenesulfonate-poly allylamine) molecules. The distance is about 2000 Å for a linear signal. See, Picart et al., “Determination of structural parameters characterizing thin films by optical methods: A comparison between scanning angle reflectometry and optical waveguide lightmode spectroscopy” J. Chem. Physics 115(2) 8 Jul. 2001, pp 1086-1094.

A detection system consists of, for example, a light source that illuminates a small spot of a biosensor at normal incidence through, for example, a fiber optic probe, and a spectrometer that collects the reflected light through, for example, a second fiber optic probe also at normal incidence. Because no physical contact occurs between the excitation/detection system and the biosensor surface, no special coupling prisms are required and the biosensor can be easily adapted to any commonly used assay platform including, for example, microtiter plates. A single spectrometer reading can be performed in several milliseconds, thus it is possible to quickly measure a large number of molecular interactions taking place in parallel upon a biosensor surface or close to a biosensor surface, and to monitor reaction kinetics in real time.

The refractive index of the optical grating can be less than the refractive index of the substrate. Layer thicknesses (i.e. cover layer, one or more specific binding substances, or an optical grating) are selected to achieve resonant wavelength sensitivity to additional molecules on the top surface. The grating period is selected to achieve resonance at a desired wavelength.

A calorimetric resonant reflectance biosensor comprises, e.g., an optical grating comprised of a high refractive index material, a substrate layer that supports the grating, and optionally one or more specific binding substances or linkers immobilized on the surface of the grating opposite of the substrate layer. Optionally, a cover layer covers the grating surface. An optical grating is coated with a high refractive index dielectric film which can be comprised of a material that includes, for example, zinc sulfide, titanium dioxide, tantalum oxide, and silicon nitride. A cross-sectional profile of a grating with optical features can comprise any periodically repeating function, for example, a “square-wave.” An optical grating can also comprise a repeating pattern of shapes selected from the group consisting of lines (one-dimensional), squares, circles, ellipses, triangles, trapezoids, sinusoidal waves, ovals, rectangles, and hexagons. A calorimetric resonant reflectance biosensor of the invention can also comprise an optical grating comprised of, for example, plastic or epoxy, which is coated with a high refractive index material.

Linear gratings (i.e., one dimensional gratings) have resonant characteristics where the illuminating light polarization is oriented perpendicular to the grating period. A calorimetric resonant reflection biosensor can also comprise, for example, a two-dimensional grating, e.g., a hexagonal array of holes or squares. Other shapes can be used as well. A linear grating has the same pitch (i.e. distance between regions of high and low refractive index), period, layer thicknesses, and material properties as a hexagonal array grating. However, light must be polarized perpendicular to the grating lines in order to be resonantly coupled into the optical structure. Therefore, a polarizing filter oriented with its polarization axis perpendicular to the linear grating must be inserted between the illumination source and the biosensor surface. Because only a small portion of the illuminating light source is correctly polarized, a longer integration time is required to collect an equivalent amount of resonantly reflected light compared to a hexagonal grating.

An optical grating can also comprise, for example, a “stepped” profile, in which high refractive index regions of a single, fixed height are embedded within a lower refractive index cover layer. The alternating regions of high and low refractive index provide an optical waveguide parallel to the top surface of the biosensor.

A calorimetric resonant reflectance biosensor of the invention can further comprise a cover layer on the surface of an optical grating opposite of a substrate layer. Where a cover layer is present, one or more specific binding substances or linkers can be immobilized on the surface of the cover layer opposite of the grating. Preferably, a cover layer comprises a material that has a lower refractive index than a material that comprises the grating. A cover layer can be comprised of, for example, glass (including spin-on glass (SOG)), epoxy, or plastic.

For example, various polymers that meet the refractive index requirement of a biosensor can be used for a cover layer. SOG can be used due to its favorable refractive index, ease of handling, and readiness of being activated with specific binding substances using the wealth of glass surface activation techniques. When the flatness of the biosensor surface is not an issue for a particular system setup, a grating structure of SiN/glass can directly be used as the sensing surface, the activation of which can be done using the same means as on a glass surface.

Resonant reflection can also be obtained without a planarizing cover layer over an optical grating. For example, a biosensor can contain only a substrate coated with a structured thin film layer of high refractive index material. Without the use of a planarizing cover layer, the surrounding medium (such as air or water) fills the grating. Therefore, specific binding substances are immobilized to the biosensor on all surfaces of an optical grating exposed to the specific binding substances, rather than only on an upper surface.

In general, a colorimetric resonant reflectance biosensor of the invention will be illuminated with white light that will contain light of every polarization angle. The orientation of the polarization angle with respect to repeating features in a biosensor grating will determine the resonance wavelength. For example, a “linear grating” (i e., a one-dimensional grating) biosensor consisting of a set of repeating lines and spaces will have two optical polarizations that can generate separate resonant reflections. Light that is polarized perpendicularly to the lines is called “s-polarized,” while light that is polarized parallel to the lines is called “p-polarized.” Both the s and p components of incident light exist simultaneously in an unfiltered illumination beam, and each generates a separate resonant signal. A biosensor can generally be designed to optimize the properties of only one polarization (the s-polarization), and the non-optimized polarization is easily removed by a polarizing filter.

In order to remove the polarization dependence, so that every polarization angle generates the same resonant reflection spectra, an alternate biosensor structure can be used that consists of a set of concentric rings. In this structure, the difference between the inside diameter and the outside diameter of each concentric ring is equal to about one-half of a grating period. Each successive ring has an inside diameter that is about one grating period greater than the inside diameter of the previous ring. The concentric ring pattern extends to cover a single sensor location—such as an array spot or a microtiter plate well. Each separate microarray spot or microtiter plate well has a separate concentric ring pattern centered within it. All polarization directions of such a structure have the same cross-sectional profile. The concentric ring structure must be illuminated precisely on-center to preserve polarization independence. The grating period of a concentric ring structure is less than the wavelength of the resonantly reflected light. The grating period is about 0.01 micron to about 1 micron. The grating depth is about 0.01 to about 1 micron.

In another embodiment, an array of holes or posts are arranged to closely approximate the concentric circle structure described above without requiring the illumination beam to be centered upon any particular location of the grid. Such an array pattern is automatically generated by the optical interference of three laser beams incident on a surface from three directions at equal angles. In this pattern, the holes (or posts) are centered upon the corners of an array of closely packed hexagons. The holes or posts also occur in the center of each hexagon. Such a hexagonal grid of holes or posts has three polarization directions that “see” the same cross-sectional profile. The hexagonal grid structure, therefore, provides equivalent resonant reflection spectra using light of any polarization angle. Thus, no polarizing filter is required to remove unwanted reflected signal components. The period of the holes or posts can be about 0.01 microns to about 1 micron and the depth or height can be about 0.01 microns to about 1 micron.

A detection system can comprise a calorimetric resonant reflectance biosensor a light source that directs light to the calorimetric resonant reflectance biosensor, and a detector that detects light reflected from the biosensor. In one embodiment, it is possible to simplify the readout instrumentation by the application of a filter so that only positive results over a determined threshold trigger a detection.

By measuring the shift in resonant wavelength at each distinct location of a calorimetric resonant reflectance biosensor of the invention, it is possible to determine which distinct locations have, e.g., material at or near the distinct location. The extent of the shift can be used to determine the amount of species in a test sample, the chemical affinity between one or more specific binding substances and the binding partners of the test sample, or the presence of an aggregating species capable of promiscuous or non-specific binding.

A calorimetric resonant reflectance biosensor can be illuminated twice. The first measurement determines the reflectance spectra of one or more distinct locations of a biosensor array with, e.g., one or more specific binding substances or linkers immobilized on the biosensor or nothing on the surface. The second measurement determines the reflectance spectra after, e.g., one or more binding partners or suspected aggregate-forming particles or promiscuous inhibitor molecules are applied to a biosensor. The difference in peak wavelength between these two measurements is a measurement of the amount of binding partners that have specifically bound to a biosensor or one or more distinct locations of a biosensor or that are associated with the biosensor at that location or presence of aggregate-forming particles. This method of illumination can control for small imperfections in a surface of a biosensor that can result in regions with slight variations in the peak resonant wavelength. This method can also control for varying concentrations or molecular weights of specific binding substances immobilized on a biosensor.

### Grating-Based Waveguide Biosensor

Grating-based waveguide biosensors are described in, e.g., U.S. Pat. No. 5,738,825. A grating-based waveguide biosensor comprises a waveguiding film and a diffraction grating that incouples an incident light field into the waveguiding film to generate a diffracted light field. A change in the effective refractive index of the waveguiding film is detected.

A grating-based waveguide biosensor can be formed of a substrate that is covered by a waveguiding film that has a higher refractive index than the substrate. The diffraction grating can be formed in the substrate, between the substrate and the waveguiding film, or in the waveguiding film. The diffraction grating can also be formed in the interface between the waveguiding film and the substrate.

The waveguiding film can be made of metal-oxide based materials such as Ta₂O₅, TiO₂, TiO₂SiO₂, HfO₂, ZrO₂, Al₂O₃, Si₃N₄, HfON, SiON, Al₂O₃ medium oxide, a mixture of SiO₂ and TiO₂ or one of the oxynitrides HfON or SiON, scandium oxide or mixtures thereof Silicon nitrides or oxynitrides (for example HfOₓN_{y}) can also be used. A waveguiding film can have a refractive index in the range of about 1.6 to about 2.5. The thickness of the waveguiding film can be about 20 to about 1000 nm. The grating coupler can have a line density of about 1000 to about 3000 lines per mm. The substrate can be, e.g., glass or plastic (polycarbonate) and can have a refractive index of about 1.3 to about 1.7.

The waveguiding film can be coated with one or more specific binding substances. The specific binding substances can bind with one or more binding partners by covalent or non-covalent binding. The waveguiding film can also be coated with linkers or can have no coating.

A detection unit can comprise (i) at least one light source to generate and direct at least one incident light field onto the diffraction grating to provide mode excitation in the waveguiding film; (ii) at least one focusing means to focus the light field diffracted out of the waveguiding film; and (iii) at least one position sensitive detector to monitor the position of the focused light field.

The incident light field can be generated by a laser. More than one incident light field can be provided in a detection unit. For example, a light field can be provided for each column of the matrix of the detection cell. If more than one light field is provided, they may be generated by providing (i) more than one light source, (ii) by splitting the field of a single light source, or (iii) by expanding a light field. Similarly more than one light detector may be provided; one light detector for each light field.

### Surface of Biosensor

One or more specific binding substances or linkers can be immobilized on a biosensor by for example, physical adsorption or by chemical binding. Alternatively, the biosensor surface can have no specific binding substances or linkers on it. A specific binding substance can be present in a purified, semi-purified or unpurified sample and can be, for example, a nucleic acid, peptide, protein solutions, peptide solutions, single or double stranded DNA solutions, RNA solutions, RNA-DNA hybrid solutions, solutions containing compounds from a combinatorial chemical library, a drug, antigen, polyclonal antibody, monoclonal antibody, single chain antibody (scFv), F(ab) fragment, F(ab′)₂ fragment, Fv fragment, small organic molecule, cell, virus, bacteria, polymer or biological sample. A biological sample can be for example, blood, plasma, serum, gastrointestinal secretions, homogenates of tissues or tumors, synovial fluid, feces, saliva, sputum, cyst fluid, amniotic fluid, cerebrospinal fluid, peritoneal fluid, lung lavage fluid, semen, lymphatic fluid, tears, or prostatic fluid. The polymer is selected from the group of long chain molecules with multiple active sites per molecule consisting of hydrogel, dextran, poly-amino acids and derivatives thereof, including poly-lysine (comprising poly-l-lysine and poly-d-lysine), poly-phe-lysine and poly-glu-lysine.

A specific binding substance specifically binds to a binding partner that is added to the surface of a biosensor of the invention. A specific binding substance specifically binds to its binding partner, but does not substantially bind other unrelated binding partners added to the surface of a biosensor. For example, where the specific binding substance is an antibody and its binding partner is a particular antigen, the antibody specifically binds to the particular antigen, but does not substantially bind other antigens lacking the specific binding site on the antigen. A binding partner can be present in a purified, semi-purified or unpurified sample and can be, for example, a nucleic acid, peptide, protein solutions, peptide solutions, single or double stranded DNA solutions, RNA solutions, RNA-DNA hybrid solutions, solutions containing compounds from a combinatorial chemical library, a drug, antigen, polyclonal antibody, monoclonal antibody, single chain antibody (scFv), F(ab) fragment, F(ab′)₂ fragment, Fv fragment, small organic molecule, cell, virus, bacteria, polymer or biological sample. A biological sample can be, for example, blood, plasma, serum, gastrointestinal secretions, homogenates of tissues or tumors, synovial fluid, feces, saliva, sputum, cyst fluid, amniotic fluid, cerebrospinal fluid, peritoneal fluid, lung lavage fluid, semen, lymphatic fluid, tears, and prostatic fluid.

Furthermore, one or more specific binding substances can be arranged in an array of one or more distinct locations on the biosensor surface, said surface residing within one or more wells of a multiwell plate and comprising one or more surfaces of the multiwell plate. The array of specific binding substances comprises one or more specific binding substances on the sensor surface within a microtiter plate well such that a surface contains one or more distinct locations, each with a different specific binding substance or with a different amount of a specific binding substance. For example, an array can comprise 1, 10, 100, 1,000, 10,000 or 100,000 distinct locations. Thus, each well of a multiwell plate can have within it an array of one or more distinct locations separate from the other wells of the multiwell plate, which allows multiple different samples to be processed on one multiwell plate of the invention. The array or arrays within any one well can be the same or different than the array or arrays found in any other microtiter wells of the same microtiter plate.

Immobilization of a specific binding substance can be affected via binding to, for example, the following functional linkers: a nickel group, an amine group, an aldehyde group, an acid group, an alkane group, an alkene group, an alkyne group, an aromatic group, an alcohol group, an ether group, a ketone group, an ester group, an amide group, an amino acid group, a nitro group, a nitrile group, a carbohydrate group, a thiol group, an organic phosphate group, a lipid group, a phospholipid group or a steroid group. Furthermore, a specific binding substance can be immobilized on the surface of a biosensor via physical adsorption, chemical binding, electrochemical binding, electrostatic binding, hydrophobic binding or hydrophilic binding.

Hydrophilic coatings on the sensor surface can be comprised of sugars, hydroxyl, polyethylene glycol, etc.

In one embodiment of the invention a biosensor can be coated with a linker such as, e.g., a nickel group, an amine group, an aldehyde group, an acid group, an alkane group, an alkene group, an alkyne group, an aromatic group, an alcohol group, an ether group, a ketone group, an ester group, an amide group, an amino acid group, a nitro group, a nitrile group, a carbohydrate group, a thiol group, an organic phosphate group, a lipid group, a phospholipid group or a steroid group. For example, an amine surface can be used to attach several types of linker molecules while an aldehyde surface can be used to bind proteins directly, without an additional linker. A nickel surface can be used to bind molecules that have an incorporated histidine (“his”) tag. Detection of “his-tagged” molecules with a nickel-activated surface is well known in the art (Whitesides, Anal Chem. 68, 490, (1996)).

Linkers and specific binding substances can be immobilized on the surface of a biosensor such that each well has the same linkers and/or specific binding substances immobilized therein. Alternatively, each well can contain a different combination of linkers and/or specific binding substances.

A binding partner or analyte can bind to a linker or specific binding substance immobilized on the surface of a biosensor. Alternatively, the surface of the biosensor can have no linker or specific binding substance and a binding partner, specific binding substance, or test molecule can bind to the biosensor surface non-specifically. Alternatively, a binding partner, specific binding substance, or test molecule does not bind to the surface of the biosensor at all.

Immobilization of one or more specific binding substances or linkers onto a biosensor is performed so that a specific binding substance or linker will not be washed away by rinsing procedures, and so that its binding to binding partners in a test sample is unimpeded by the biosensor surface. Several different types of surface chemistry strategies have been implemented for covalent attachment of specific binding substances to, for example, glass for use in various types of microarrays and biosensors. These same methods can be readily adapted to a biosensor of the invention. Surface preparation of a biosensor so that it contains the correct functional groups for binding one or more specific binding substances is an integral part of the biosensor manufacturing process.

One or more specific binding substances can be attached to a biosensor surface by physical adsorption (i.e., without the use of chemical linkers) or by chemical binding (i.e., with the use of chemical linkers) as well as electrochemical binding, electrostatic binding, hydrophobic binding and hydrophilic binding. Chemical binding can generate stronger attachment of specific binding substances on a biosensor surface and provide defined orientation and conformation of the surface-bound molecules.

Immobilization of specific binding substances to plastic, epoxy, or high refractive index material can be performed essentially as described for immobilization to glass. However, the acid wash step can be eliminated where such a treatment would damage the material to which the specific binding substances are immobilized.

### Methods of Detection

Methods of the invention can be used to detect test species having a molecular weight of about 100 Da to about 2,000 Da that can, for example, form aggregates of about 20 nm to about 500 nm, or promiscuously inhibit binding reactions. The methods of the invention can detect these aggregates prior to any precipitation of the aggregates. Aggregate-forming particles that are capable of promiscuous or non-specific binding can form large colloid-like aggregates due to, e.g., chemical reactivity, interference in assay read-out, high molecular flexibility or hydrophobicity. See, e.g., Feng et al., 2005 Nature Chem. Biol. 1(3):146. Aggregate-forming particles and promiscuous inhibitors can greatly interfere with high-throughput screening of libraries of chemical compounds. Typically, methods employed for high-throughput screening of libraries due to their indirect measurement of binding are incapable of measuring stoichiometric or activity specificity of small molecules. Therefore, the identification of molecules with aggregating and/or non-specific binding properties is desirable.

In one embodiment, the invention provides microtiter well plate-based biosensor systems capable of highly quantitative binding analyses. The signal (PWV shift, measured in nm or change in refractive index) obtained when a molecule binds directly to a biosensor or to an immobilized target, is directly proportional to the mass of the molecule bound. The maximum PWV shift expected from the binding of a ligand to its immobilized target can be calculated using the formula:

ligand PWV Shift_{expected}=(MW ligand/MW target)×(PWV target)×n×F target activity

where n=number of binding site per molecule of target (i.e., stoichiometric ratio) and F is the fraction of the immobilized target that is functional for ligand binding. In well-behaved small molecule binding systems, equilibrium can often be reached within a short period of time or less than a few seconds. Signals measured from a system at equilibrium are described as stable or unchanging with respect to time unless some outside force is acting upon the system. A discontinuous, sloping, or non-linear set of signals from a system may be interpreted to mean that an equilibrium state has not been reached or has taken longer to reach. In the case of the present invention as applied to photonic crystal biosensors or calorimetric resonant reflectance biosensors designed to measure peak wavelength value shifts, shifts of greater than about 2 picometer/minute or first derivative values thereof are indicative of discontinuous, sloping, or non-linear responses.

Methods of the invention can be used to detect promiscuous inhibitor or non-specific binding molecules (e.g., molecules that bind a multitude of other molecules at a stoichiometry ratio of equal to or greater than 1:1). Methods of the invention can also be used to detect aggregate-forming particles that are comprised of a multitude of smaller molecules that are capable of binding other molecules at a stoichiometry ratio of equal to or greater than 1:1. Aggregate-forming particles may not necessarily bind other molecules or bind with any specificity; they may just be in suspension. Aggregate-forming particles can be detected using, e.g., a biosensor with a hydrophilic coating or common protein coating (e.g., BSA coating) that can be used to detect PWV shifts (e.g., 20-100 picometers at less than about 50 μM concentration in solution) or refractive index changes for aggregate-forming particles. The invention may be easily practiced by adding the suspect aggregate-forming particle or promiscuous inhibitor molecule to the biosensor in the range of about 20, 30, 40, or 50 μM concentration (e.g., 50 μM concentration) and observing the peak wavelength value shift (or refractive index changes) for changes greater than 20-100 picometers. The invention may be practiced as a method to test for buffer conditions that reduce the aggregating or promiscuous property of the molecule. Where the changes are observed, the molecules are indeed aggregate-forming or promiscuous inhibitor molecules.

Generally, well-behaved compounds are anticipated to specifically bind to a target molecule with a measured stoichiometry of about 1:1. The stoichiometry would ideally be normalized to that seen at saturation with a standard binder to account for the level of functional activity of the target. Higher apparent stoichiometry ratios (e.g., 1:1.5, 1:2, 1:3, 1:4, 1:5, etc.) can suggest an element of non-specific binding or aggregations. In cases where higher stoichiometric ratios are anticipated, the same inferences may be made where the empirical PWV shift is greater than calculated based upon the higher stoichiometric ratio.

For most target molecules with K_{d}s in the range of 0.1 to 1,000 μM, the association rate constant for a drug-like small molecule binding to a target molecule (i.e., specific binding) will be upwards of 10⁶ M⁻¹s⁻¹, and often 10⁷ or higher and more specifically greater than the rate of diffusion based upon the specific buffers and test conditions being employed. At 10⁶ M⁻¹s⁻¹, with a 10 μM compound, the on-rate would be 10 s⁻¹, corresponding to a half-time association of just 1 second. Specific binding demonstrates a t1/2 of less than about 10-20 seconds. Thus, binding is complete within 1 second, and well before the first PWV or refractive index read after addition. Any slower binding is indicative of either non-specific binding, aggregation or on rare occasions a rate limiting structural change in the target or ligand.

### Single Concentration Assays

A high throughput screen (HTS) can test small molecule compounds at, for example, 0.1 to about 10 μM concentration in about 0.1% to about 2% DMSO or 10 μM-1 mM concentration and up to 5% DMSO. A similar protocol can be used as an orthogonal screen for secondary characterization of hits from uHTS campaigns that have a high rate of actives (e.g., false positives from aggregation or fluorescence interference).

Many small molecule compound libraries are stored at 100% DMSO. As a molecule is diluted into aqueous buffers more amenable to biological target activity, a time dependent function of aggregation formation can be found. One of the abilities of the present invention is detection of a slower increase in PWV shift associated with this time dependent aggregate particle formation.

In one example, a specific binding substance, binding partner, or linker-coated biosensor microplate can be equilibrated in assay buffer. A baseline can be recorded for about 1 to about 5 minutes to determine the biosensor starting PWV or refractive index and stability. The biosensor microplate can be moved to a liquid handling platform for uniform, simultaneous addition of test species or other molecules to all the wells on the biosensor (including a quick mixing action if required) or the test species can be added and mixed, if required, manually. The biosensor plate is then read in real time or at several time points by a detection instrument. A time course of the binding interaction can be read and recorded over, for example, 30 seconds, 1, 2, 3, 4, 5, 10, 20, 30 minutes or more. In one embodiment of the invention, the biosensor does not have specific binding substances, binding partners, or linkers bound to its surface. The biosensor surface may be hydrophilic. Label-free screening methods can be subject to DMSO mismatch responses from variations in DMSO derived from compound libraries. DMSO mismatch can be minimized by optimizing assay protocols and reducing DMSO mismatches through careful calculations and liquid handling technique.

Table 1 details categories of expected responses for single concentration screening of small molecules at, e.g., 5, 10, 25 μM or other concentration. The most well behaved compound type (i.e., a specific binding compound) is shown at the top row of the table and compounds that are the least likely to be a true hit (e.g., an aggregate-forming particle or promiscuous binding molecule) are shown as the last row in the table.

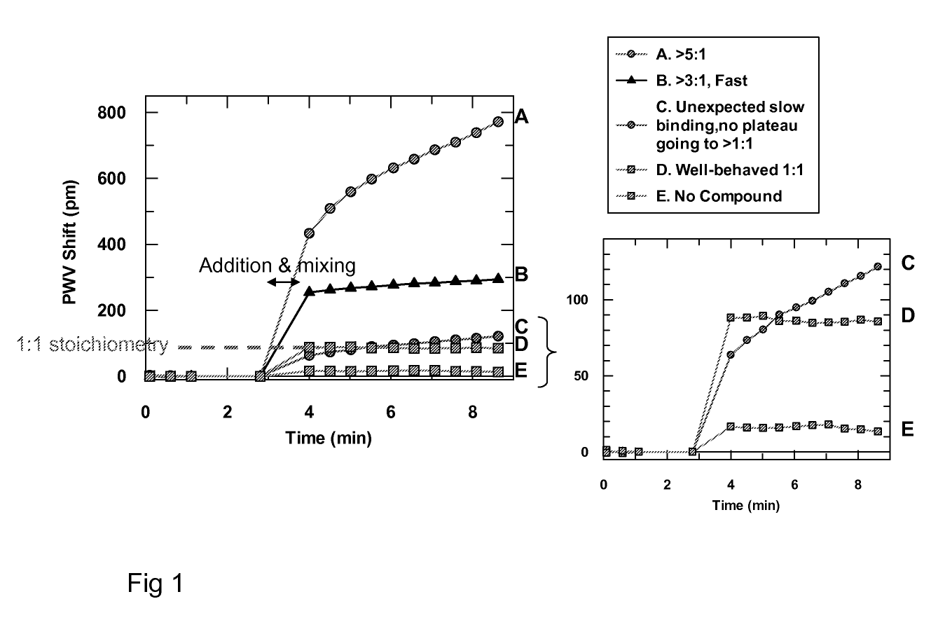

TABLE 1

| Apparent | | | |
|---|---|---|---|
| stoichiometry | | | |
| from initial | Information from | Most likely | |
| PWV Shift | time-course | interpretation | Further information |
| ≦1:1 | Complete response | a) specific binder | a) or b): perform dose- |
| | within mixing time | b) non-specific | response to determine K_{d}, |
| | (see D in FIG. 1) | binder assayed at | stoichiometry of specific |
| | | non-saturating | binding. This also |
| | | concentration | identifies any non-specific |
| | | | component. |
| ≦1:1 | Slow monophasic | Slow-binding, | Consider that binding |
| | response from zero | mechanistically | requires the target to |
| | to <1:1 (not shown in FIG. 1) | interesting | undergo a conformational |
| | | compound | change. Perform a dose- |
| | | | response, with sufficiently |
| | | | long time-course to |
| | | | achieve equilibrium to |
| | | | confirm 1:1 specific |
| | | | binding, but slow binding. |
| Between 1:1 | Either, complete | a) specific binder, | a) or b): Perform a dose- |
| and 5:1 | response within | combined with | response curve to look for |
| | mixing time (see B | non-specific | a specific binding |
| | in FIG. 1); | binding | component. |
| | Or | component | c) identification from |
| | Slow response, | b) slow-binding, | shape of dose-response |
| | often without | non-specific | curve using appropriate |
| | achievement of an | binding | concentration range where |
| | equilibrium level | compound | specific binding |
| | (see C in FIG. 1) | c) potent binder | observation is desired and |
| | | with significant | generally in the range of |
| | | non-specific | the apparent K_{d} (if the |
| | | binding, when | molecule is a weak binder, |
| | | assayed at >>K_{d} | concentrations up to 1 mM |
| | | | may need to be used. |
| >5:1 | Rapid or slow | Most likely | |
| | binding (see A in | binding of non- | |
| | FIG. 1) | specific | |
| | | compound | |

Therefore, where molecules bind to specific binding substances, binding partners, or linkers immobilized on the surface of a biosensor with a stoichiometry ratio of equal to or greater than about 1:1, 1:2, 1:3, 1:4, 1:5, 1:6, 1:7, 1:8, 1:9, 1:10 or more and/or with a discontinuous or non-linear peak wavelength shift or refractive index over time (e.g., 30 seconds, 1, 2, 3, 4, 5, 6, 7, 8, 9, 10, or more minutes) (see FIG. 1) the molecules are aggregate-forming particles or promiscuous inhibitor molecules.

In one embodiment, the stoichiometric binding ratios and PWV or refractive index readings can be determined for a test species on 2, 3, 4, 5, 6, or more differently coated biosensor surfaces. That is, the biosensor surface has different specific binding substances, binding partners, or linkers such as bovine serum albumin, human serum albumin, casein, milk, analogous or homologous target proteins, or other materials of knowledge to one of skill in the art of non-specific binding. The same or similar results on the differing surfaces can provide confirmation of the results.

### Compound Secondary Analysis; Dose Response Curves

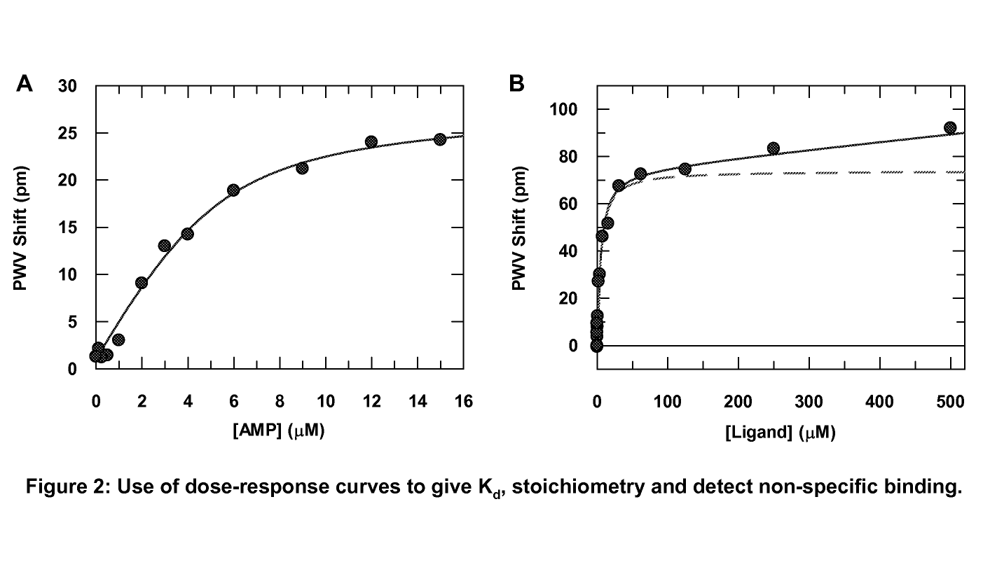

Generally, well-behaved compounds with K_{d}s in the concentration range of 0.5 to 1,000 μM, will give a dose-response curve that shows saturation with a stoichiometry consistent with 1 molecule of ligand bound per binding site and a K_{d} compatible with solution measurement. With industry standard 96- and 384-well biosensor plates, dose-responses can be readily obtained in high throughput and the resulting data fitted to appropriate 1:1 binding molecules to derive K_{d} and stoichiometry. Moreover, appropriate models can be utilized that allow the discrimination of a saturable specific binding component from any non-specific responses. See FIG. 2. Such data can generally be obtained by titrations on a target molecule coated surface and do not require reference or control surfaces. The data from dose response curves can greatly increase the confidence in discriminating specific responses from non-specific responses, as well as giving highly quantitative affinity data for specific binders.

In one embodiment of the invention, a promiscuous inhibitor species or aggregate-forming particle is detected or differentiated from specific binding molecules by applying a test species to a calorimetric resonant biosensor or a grating-based waveguide biosensor and illuminating the biosensor with light. A significant or discontinuous refractive index change with regard to increasing concentration of the test species indicates that the test species is an aggregate-forming particle or promiscuous inhibitor molecule capable of promiscuous or non-specific binding inhibition. In one embodiment of the invention, subsequent additions of the potential aggregate-forming particles to one well or biosensor surface after each detection is done to raise the concentration within the well or on the surface. Alternatively, wells or surfaces can be loaded with multiple, differing concentrations of the test species. The biosensor surface can have specific binding substances, binding partners, or linkers immobilized to its surface. Alternatively, the biosensor can have no molecules immobilized to it and may optionally have a hydrophilic surface.

In another embodiment of the invention, aggregate-forming particles can be detected or differentiated from non-specific binding species by comparison of the PWV shift or refractive index changes measured with one or more coated biosensor surfaces. By first placing the aggregate-forming particles into a biosensor plate or well with a surface that has been made very hydrophilic and then comparing the PWV shift from this first step with the PWV shift when the aggregate-forming particles has been added to a biosensor surface that has immobilized target species (specific binding substance, binding partner or linker) on it, one can determine the aggregation properties of the test molecule. PWV shifts or refractive index changes on the target immobilized surface that are significantly higher as compared to the hydrophilic surface indicates that the test molecules non-specifically bind. In the case where the hydrophilic surface has a significantly higher PWV shift or refractive index change than the target species coated surface, an aggregating molecule is suspected. Additionally, where higher PWV shift or refractive index change than 1:1 stoichiometry is measured for both surfaces, promiscuous binding and aggregation is inferred.

In another embodiment, a biosensor of the invention can be used to study the effect of detergents on the aggregate-forming particles (J. Med. Chem. 2003, 46, 3448-3451). One embodiment monitors the changes of the PWV shift or refractive index changes at a fixed concentration of the aggregate-forming particles and titrating conditions of a detergent or chaotropic agent employed at above and below sub-micellular forming concentrations (“CMC”). A reduction of the PWV shift upon addition of a detergent or chaotropic agent at concentrations above the CMS is indicative of reduction of the aggregation of the molecule. Another embodiment comprises immobilizing the enzyme beta-lactamase on a biosensor of the invention and monitoring it for the ability to attract non-specific binding compounds at greater than stoichiometric amounts as the protein has been historically used to characterize promiscuous and aggregating compounds, is easily obtained, has enzymatic activity that can be measured by orthogonal methods, and has similar activities at higher levels of detergent.

Where the molecular weight of a monomer form of a promiscuous inhibitor molecule or aggregate-forming species is known, the expected shift the promiscuous inhibitor species would give if it were simply and specifically binding to the biosensor can be calculated. Shifts greater than this calculated level can be indicative of an aggregation event or nonspecific binding. Many promiscuous inhibitor molecules appear to aggregate at the same concentration range between about 10 μM to about 50 μM or about 1 μM to about 200 μM. This may be a function of the fact that they all occupy approximately the same space/volume and/or have similar non-polar nature.

A test species (e.g., a potential aggregate-forming species or promiscuous inhibitor) can have a molecular weight of about 50, 100, 200, 300, 400, 500, 600, 700, 800, 900, 1,000, 2,000, or more Da (or any value or range between about 50 and 2,000 Da). The test species can have a concentration of about 0.1. 0.5, 1.0, 5, 10, 25, 50, 75, 100, 200, 300, 400, 500 μM or more (or any value or range between about 0.1 and 500 μM). In one embodiment of the invention the test species has a concentration of about 0.25 μM to about 10 μM. The test species can be in 0.01, 0.1, 0.5, 1.0, 1.5, 2.0, 3.0, 3.5, 4.0, 5.0 or more percent DMSO.

The PWV shift refractive index change can be measured over an about 15, 30, 45 seconds to about a 1, 2, 5, 10, 15, 30, 60, 120 minutes or more (or any value or range between about 15 seconds and 120 minutes) time period. The measurements can be taken in real time (constant measurements) or at specific, individual time points. In one embodiment of the invention, the PWV shift or refractive index change is measured over an about 1 to about 5 minute or 10 minute time period.

A discontinuous or non-linear PWV shift or refractive index change with regard to increasing concentration of the test species indicates that the test species is a promiscuous inhibitor species. For example, where:

Y=mX+b

and Y=PWV shift, X=concentration of small molecule, m=the slope of the line, and b is the y-intercept, and where the correlation coefficient for the number of concentrations tested for signal falls at the 99% probability limit for correlation. The titration curves for those molecules falling below the 99% confidence interval for the correlation coefficient to a linear fit would be indicative of an aggregating compound with the capability to inhibit proteins in a promiscuous or non-specific manner. See, An Introduction to Error Analysis—The Study of Uncertainties in Physical Measurements, John R. Taylor, University Science Books, Mill Valley, Calif., 1982, Chaps 8&9.

Additionally, a discontinuous or non-linear refractive index change that is greater than that calculated based upon the amount of test species immobilized on the biosensor and with regard to increasing concentration of the test species indicates that the test species is an aggregate-forming particle or promiscuous inhibitor or non-specifically binding.

The anticipated shift for a binding molecule can be calculated from the amount of molecule added to the biosensor and the current value for the correspondence between PWV and mass attached to or near the surface to the biosensor. For example:
2.66 ng/mm² bound to the biosensor=1 nm of PWV shift sensitivity in the case of one model of the sensor, thus if 50 uL of a 2 uM molecule of 300 MW is added to the biosensor and all of it bound to the biosensor, we could anticipate about

300 ng/nmol*2000 nmol/L*0.00005 L*1/30 mm²=1 ng/mm² or 1/2.66 nm=376 pm PWV shift.

In practice, not all of the aggregating molecules bind to the biosensor, but shifts considerably greater than 376 pm for molecule addition have been observed. Values for PWV shifts greater than this calculated maximum are indicative of an aggregating compound capable of promiscuous or non-specific inhibition of proteins.

The amount of PWV shift anticipated for a non-promiscuous or binding partner molecule can be calculated if a specific binding substance or linker is immobilized onto the biosensor surface.

PWV shift from the non-promiscuous or binding partner molecule immobilization is multiplied by the ratio of the MW of non-promiscuous or binding partner molecule/MW of linker or specific binding substance =theoretical shift for the non-promiscuous or binding partner molecule addition, where MW is the molecular weight of the species. For a typical scenario:

1. Specific binding substance, binding partner, or linker (50,000 MW) immobilizes with 6 nm of PWV shift;

2. Non-promiscuous or binding partner molecule of 300 MW is added

3. Theoretical binding is 6*300/50,000*1 (i.e., the stoichiometric ratio)=36 pm PWV shift.

4. PWV shifts 2×-3× greater than this figure are indicative of promiscuous or non-specific binding. This calculation in general has a lower limit of detecting an aggregate-forming particle or promiscuous inhibitor molecule than the situation where no specific binding substance, binding partner or linker is present on the surface of the biosensor.

### Competition Assays

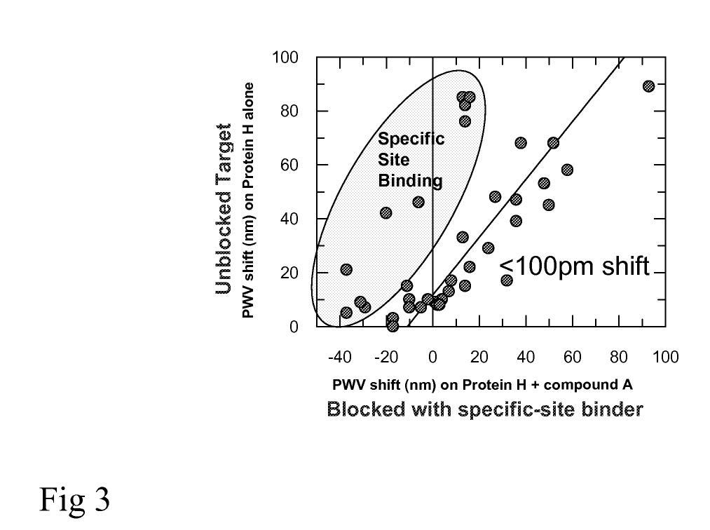

When a standard specific-binding compound that occupies a specific site is available or is discovered during the screening process, the methods of the invention can provide a very effective way of distinguishing specific site binders from any non-specific or alternative site binders. Pairs of specific binding substance, binding partner, or linker-coated biosensor plates or wells are used. The known site-binder is added to one specific binding substance, binding partner, or linker-coated biosensor plates or wells at a sufficient concentration to prevent binding by test compounds at that site. The set of test compounds is then added to both plates or wells. The known site binder is added to both plates or wells. The difference in response between the two plates or wells to the test compounds is a direct measurement of specific-site binding and readily identifies alternative site binding. See FIG. 3.

The invention provides methods of detecting promiscuous inhibitor molecules or aggregate-forming particles using competition assays. A biosensor can have one or more types of target molecules comprising one or more specific binding sites for a ligand immobilized on the first location and a second location (or more locations) of the biosensor. A ligand that specifically binds the one or more binding sites of the target molecules is added to a first location of a biosensor. A test species to then added to the first and second locations of the biosensor. In one embodiment of the invention, the test species has the same or similar molecular weight as the ligand (e.g. about 10, 5, 4, 3, 2, 1% or less difference between the two molecular weights). The ligand is then added to both the first and the second locations of the biosensor.

The PWVs or refractive indices for the locations are determined in real time and the stoichiometry ratios of binding between the ligand and the target molecule are determined. Also, a first PWV or refractive index measurement is determined after the ligand is added to the first location of the biosensor and before the test species is added to the first and second locations. A second PWV or refractive index measurement is determined after the test species is added to the first and second locations of the biosensor and before the ligand is added the both the first and second locations. The first and second PWV or refractive index measurements are compared. If a PWV or refractive index change is seen between the two measurements then the test species is a potential promiscuous inhibitor. Examination of the stoichiometric ratios of the binding reactions can further define the test species. If the stoichiometric ratio is less than 1:1 (e.g., 0.9:1, 0.8:1, 0.7:1, 0.5:1, etc.), then the test species can be specifically binding to a second specific binding site on the target molecule (that is different from the initial specific binding site). If the stoichiometric ration is greater than 1:1 (e.g. 1:1.5, 1:2, 1:3, 1:4, 1:5, etc.) then the test species can be an aggregate-forming particle or a promiscuous binder. Furthermore, it the binding is based mostly upon affinity determined by fitting standard titration data (e.g., less than about 100 μM is considered low specificity) and the stoichiometry ratio is less than 1:1, then the test species can be a promiscuous inhibitor or binding with low specificity to the target molecule.

In all methodologies of the invention a biosensor surface can be washed before or after any addition to the biosensor surface (e.g., addition of a test species or ligand molecule). Alternatively, the biosensor surface can remain unwashed before or after each addition to the biosensor surface.

### Compound Aggregation and Insolubility Issues.

Where compound aggregation or insolubility issues occur several factors can be adjusted to control the problem. Compound aggregations are concentration dependent. Therefore, running assays at the lowest compound concentration consistent with the ability to detect binding can reduce compound aggregation. Compound aggregation is also dependant on the protocol for dilution from DMSO into aqueous buffer. A direct single dilution from stock in DMSO into the final DMSO concentration followed quickly by screening can reduce compound aggregation. Small amounts of detergents (e.g., 0.01% v/v TWEEN®-20 or BSA (<10 μM)) in the binding buffer can reduce aggregation. Compounds that are known to precipitate at the concentrations tested should be centrifuged or filtered and retested to confirm the binding mechanism.

Detection distance of a Biosensor Detection System

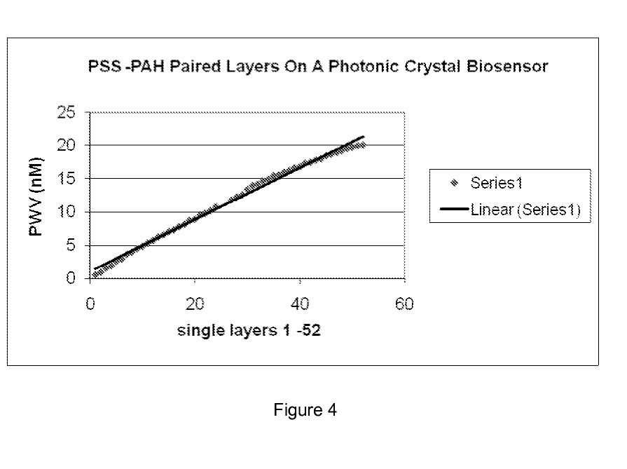

The detection distance from the surface of the calorimetric resonant reflectance biosensor or a grating-based waveguide biosensor surface can be important in detecting promiscuous inhibitor molecules or aggregate-forming particles. FIG. 4 demonstrates the biosensor signal as a function of the distance of the added material to the sensor surface. Paired layers of electrostatically attracted partners PSS (polystyrenesulfonate) and PAH (poly(allylamine hydrochloride) are added to the photonic crystal biosensor and the biosensor signal is recorded for each added layer. The data contained in this graph demonstrate that the biosensor signal is linear to an approximation (correlation coefficient 0.991 for the range shown) out to 260 nm. This is based upon the literature reported function of the thickness of each pair of bound polymers adding 10 nm±0.8 nm. See, Caruso et al., Langmuir (1997) 13:3422-3426. The present invention provides a detection device that is able to measure a significant distance from the surface of the biosensor in order to accurately detect and characterize promiscuous inhibitor molecule and aggregate-forming particle binding events and the presence of aggregate-forming particles. Most detection systems detect molecules at about 100 nm from the biosensor surface. However, more accurate detection can be obtained by detecting molecules at about 105, 125, 150, 175, 200, 225, 250, 275, 300 nm or more from the surface of the biosensor.

### ADVANTAGES OF METHODS OF THE INVENTION

The methods of the invention provide many advantages in detecting aggregate-forming particles or promiscuous inhibitor molecules. The equilibrium binding measurements determined by the method of the invention quantify stoichiometry and binding affinity. The short time courses used in the methods of the invention give extra information in distinguishing specific from non-specific hits by study of the slope of the time versus PWV shift or refractive index change data, with greater slope indicating greater likelihood of non-specific or aggregating activity. The methods provide identification of mechanistically unacceptable compounds both in primary screening mode and in orthogonal secondary screens. The progression of single concentration hits via dose-response curves and competition experiments increases confidence in the quality and specificity of hits. Furthermore, the methods of the invention have significant advantages over the use of flow-SPR and other label free methods. For example, using the methods of the invention, a direct assay in a range of standard microplate formats (e.g., 96-, 384, and 1536-well) gives very high throughput (up to a million data points in an 8 hour day) with a simple to use, automation friendly reader. A single result from a single well avoids the complications sometimes seen with time or reagent denatured targets and regenerated surfaces. Multiple dose-response curves are obtained quickly and simultaneously giving excellent quality control and high throughput.

All patents, patent applications, and other scientific or technical writings referred to anywhere herein are incorporated by reference in their entirety. The invention illustratively described herein suitably can be practiced in the absence of any element or elements, limitation or limitations that are not specifically disclosed herein. Thus, for example, in each instance herein any of the terms “comprising”, “consisting essentially of”, and “consisting of” may be replaced with either of the other two terms, while retaining their ordinary meanings. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by embodiments, optional features, modification and variation of the concepts herein disclosed may be resorted to by those skilled in the art, and that such modifications and variations are considered to be within the scope of this invention as defined by the description and the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

We claim:

1. A method of detecting aggregate-forming particles or promiscuous inhibitor molecules comprising:
(a) applying test species to a colorimetric resonant reflectance biosensor or a grating-based waveguide biosensor; and
(b) illuminating the biosensor with light and determining peak wavelength value shifts or refractive index changes over time;
wherein, discontinuous, non-linear, or slope of greater than 2 pm/minute peak wavelength value shifts or refractive index changes over time indicates that the test species are aggregate-forming particles or promiscuous binding molecules.

2. The method of claim 1, wherein the biosensor has one or more specific binding substances, binding partners or linkers immobilized on a surface of the biosensor.

3. The method of claim 3, wherein the stoichiometry of a binding reaction between the test species and the one or more specific binding substances, binding partners or linkers greater than about 1:1, thereby indicating that the test species are aggregate-forming particles or promiscuous binding molecules.

4. The method of claim 1, wherein the biosensor has a hydrophilic coating on the biosensor surface.

5. The method of claim 1, wherein the refractive index change or peak wavelength value shift is continuously measured over an about 15 second to about a 10 minute time period.

6. The method of claim 1, wherein the biosensor is a bottom surface of one or more microtiter wells.

7. The method of claim 6, wherein the test species is added at several different concentrations to several different microtiter wells.

8. The method of claim 1, wherein the peak wavelength values or refractive index values are determined at a distance of about 100 up to about 300 nm off of the surface of the biosensor.

9. A method of detecting non-specific binding of a test species comprising:
(a) applying test species to a colorimetric resonant reflectance biosensor or a grating-based waveguide biosensor, wherein the biosensor has one or more specific binding substances, binding partners or linkers immobilized on a surface of the biosensor; and
(b) illuminating the biosensor with light and determining peak wavelength value shifts or refractive index changes over time;
wherein, discontinuous, non-linear, or slope of greater than 2 pm/minute peak wavelength value shifts or refractive index changes over time indicates that the test species is non-specifically binding.

10. The method of claim 9, wherein the stoichiometry of a binding reaction between the test species and the one or more specific binding substances, binding partners or linkers greater than about 1:1, thereby indicating that the test species is non-specifically binding.

11. The method of claim 9, wherein the refractive index change or peak wavelength value shift is continuously measured over an about 15 second to about a 10 minute time period.

12. The method of claim 9, wherein the peak wavelength values or refractive index values are determined at a distance of about 100 up to about 300 nm off of the surface of the biosensor.

13. The method of claim 9, wherein the biosensor is a bottom surface of one or more microtiter wells.

14. The method of claim 13, wherein the test species is added at several different concentrations to several different microtiter wells.

15. A method of detecting non-specific binding of a test species comprising:
(a) applying a test species at varying concentrations to two or more locations on a calorimetric resonant biosensor or a grating-based waveguide biosensor, wherein the biosensor has one or more specific binding substances, binding partners, or linkers immobilized to the biosensor surface; and
(b) illuminating the biosensor with light and detecting peak wavelength values or refractive index values for each of the two or more locations;
wherein, a discontinuous, non-linear, or slope of greater than 2 pm/minute refractive index change with regard to increasing concentration of the test species indicates that the test species is non-specifically binding.

16. The method of claim 15, wherein the stoichiometry of a binding reaction between the test species and the one or more specific binding substances, binding partners or linkers greater than about 1:1, thereby indicating that the test species is non-specifically binding.

17. The method of claim 15, wherein the refractive index change or peak wavelength value shift is continuously measured over an about 15 second to about a 10 minute time period.

18. The method of claim 15, wherein the peak wavelength values or refractive index values are determined at a distance of about 100 up to about 300 nm off of the surface of the biosensor.

19. The method of claim 15, wherein the biosensor is a bottom surface of one or more microtiter wells.

20. The method of claim 19, wherein the test species is added at several different concentrations to several different microtiter wells.

21. A method of detecting aggregate-forming particles or promiscuous inhibitor molecules comprising:
(a) applying a test species at varying concentrations to two or more locations on a calorimetric resonant biosensor or a grating-based waveguide biosensor; and
(b) illuminating the biosensor with light and detecting peak wavelength values or refractive index values for each of the two or more locations;
wherein, discontinuous, non-linear or slope of greater than 2 pm/minute peak wavelength shift or refractive index change with regard to increasing concentration of the test species indicates that the test species is an aggregate-forming particle or a promiscuous inhibitor.

22. The method of claim 21, wherein the biosensor has one or more specific binding substances, binding partners, or linkers immobilized to the biosensor surface.

23. The method of claim 22, wherein the stoichiometry of a binding reaction between the test species and the one or more specific binding substances, binding partners or linkers greater than about 1:1, thereby indicating that the test species are aggregate-forming particles or promiscuous binding molecules.

24. The method of claim 21, wherein the biosensor has a hydrophilic coating on the biosensor surface.

25. The method of claim 21, wherein the peak wavelength values or refractive index values are determined at a distance of about 100 up to about 300 nm off of the surface of the biosensor.

26. The method of claim 21, wherein the refractive index change or peak wavelength value shift is continuously measured over an about 15 second to about a 30 minute time period.

27. The method of claim 21, wherein the biosensor is a bottom surface of one or more microtiter wells.

28. The method of claim 27, wherein the test species is added at several different concentrations to several different microtiter wells.

29. A method of detecting promiscuous inhibitor molecules or aggregate-forming particles comprising:
(a) applying a ligand to a first location of a biosensor, wherein the biosensor has a target molecule comprising a specific binding site for the ligand immobilized on the first location and a second location of the biosensor;
(b) applying a test species to the first and second locations of the biosensor;
(c) applying a molecule known to bind to the target molecule at the specific binding site of the target molecule to the first and the second locations of the biosensor;
(d) illuminating the biosensor with light and determining peak wavelength value shifts or refractive index changes at steps (a)-(c) and determining stoichiometric ratios of binding reactions at the first and second locations of the biosensor; thereby detecting promiscuous inhibitor molecules or aggregate-forming particles.

30. The method of claim 29, wherein the peak wavelength values or refractive index values are determined at a distance of about 100 up to about 300 nm off of the surface of the biosensor.
